(19) United States
(12) Patent Application Publication
(10) Pub. No.: US 2022/0250758 A1
(43) Pub. Date: Aug. 11, 2022

(54) REMOTE MOUNT OF ENGINE ACCESSORIES

(71) Applicant: General Electric Company, Schenectady, NY (US)

(72) Inventor: Brian Lewis Devendorf, Georgetown, MA (US)

(21) Appl. No.: 17/168,772

(22) Filed: Feb. 5, 2021

(51) Int. Cl. B64D 31/00; B64D 29/02; B64D 37/30; B64D 33/08; B64D 33/02

(52) U.S. Cl. CPC B64D 31/00; B64D 29/02; B64D 2033/0286; B64D 33/08; B64D 33/02; B64D 37/30

(57) ABSTRACT

An aircraft includes a fuselage, a wing connected to and extending from the fuselage, a pylon mounted to a portion of the wing, an engine attached to the pylon, and an accessory system. The accessory system is mounted remotely from the engine and includes at least one of a fuel pump and a lubrication system. The fuel pump is disposed to supply fuel to portions of the engine and is the downstream-most fuel pump in fluid communication with the combustion section. The lubrication system is disposed to provide oil to portions of the engine.

### FIELD

The present disclosure relates to engine accessories of a gas turbine engine. In particular, the present disclosure relates to mounting locations for engine accessories of a gas turbine engine.

### BACKGROUND

A gas turbine engine generally includes a turbomachine and a rotor assembly. Gas turbine engines, such as turbofan engines, may be used for aircraft propulsion. In the case of a turbofan engine, the rotor assembly may be configured as a fan assembly.

In existing gas turbine engines, engine accessories such as oil and lubrication systems are traditionally mounted to the engine on an accessory gearbox. As gas turbine engine cores continue to get smaller, a cross-sectional area of the engine is a contributor to overall aircraft drag. With engine accessories being mounted to the engine on an accessory gearbox, minimization of the cross-sectional area of the engine can be limited due to the size of the accessory gear box.

### BRIEF DESCRIPTION

Aspects and advantages of the disclosure will be set forth in part in the following description, or may be obvious from the description, or may be learned through practice of the disclosure.

In one exemplary embodiment of the present disclosure, an aircraft includes a fuselage, a wing connected to and extending from the fuselage, a pylon mounted to a portion of the wing, an engine attached to the pylon, and an accessory system. The accessory system is mounted remotely from the engine and includes at least one of a fuel pump and a lubrication system. The fuel pump is disposed to supply fuel to portions of the engine and is the downstream-most fuel pump in fluid communication with the combustion section. The lubrication system is disposed to provide oil to portions of the engine.

In one exemplary embodiment of the present disclosure, an engine assembly for an aircraft includes an engine, an electrical system, and an accessory system. The engine includes a compressor section, a combustion section, and a turbine section in serial flow order. The engine further includes a rotating shaft rotatable with the compressor section, the turbine section, or both. The electrical system includes an electric machine rotatable with the rotating shaft and is configured to generate electric power. The accessory system is mounted remotely from the engine and is disposed to be driven separately from the rotating shaft of the engine.

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1A is a schematic, cross-sectional view of a first gas turbine engine in accordance with an exemplary embodiment of the present disclosure.

FIG. 1B is a simplified schematic view of the first gas turbine engine mounted on an aircraft with engine accessories mounted off and away from the gas turbine engine.

FIG. 2A is a schematic, cross-sectional view of a second gas turbine engine in accordance with another exemplary embodiment of the present disclosure.

FIG. 2B is a simplified schematic view of the second gas turbine engine mounted on an aircraft with an un-ducted fan arrangement and shows engine accessories mounted off and away from the gas turbine engine.

FIG. 3 is a simplified schematic view of a turboshaft assembly of a gas turbine engine and shows engine accessories mounted outside of a heat zone of the turboshaft assembly.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The present disclosure proposes engine accessory systems, such as fuel and oil subsystems of the engine, being mounted remotely from the engine and, e.g., into different aircraft cavities that are otherwise unoccupied. For example, under-wing engines could locate the accessory systems in the pylon or in the wing of the aircraft. Fuselage mounted engines could locate the accessory systems in the mounts or in the fuselage. The accessory systems would be powered in a manner that decouples them from the engine's gearbox, such as electrically. These arrangements potentially eliminate the need for the accessory gearbox, while locating the components in a more benign thermal and vibratory environment thereby minimizing wear on the accessory systems. The component mounting location may be selected to reduce total aircraft frontal area, optimizing overall drag and weight.

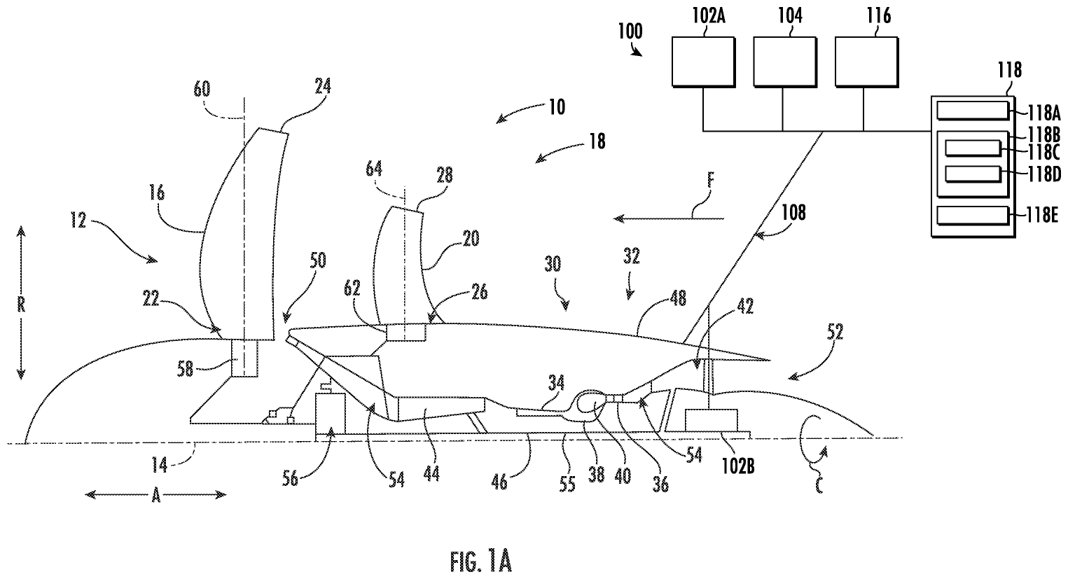

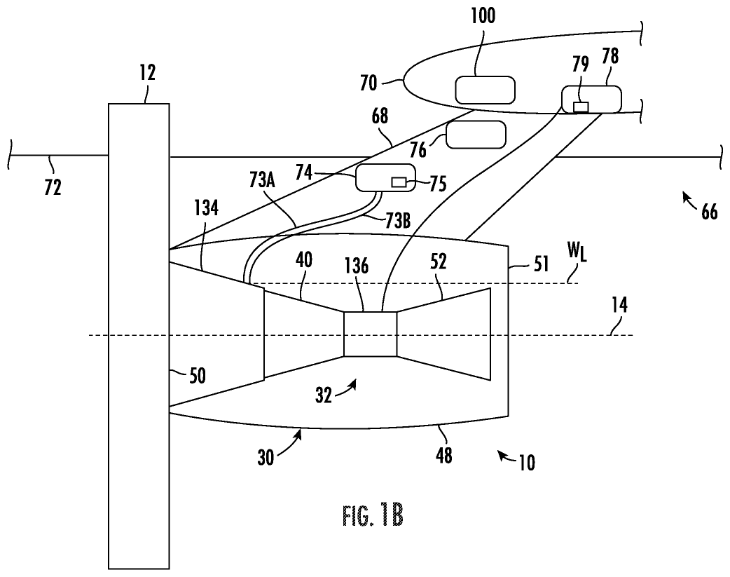

Referring now to FIG. 1A, a cross-sectional view of an exemplary embodiment of a gas turbine engine as may incorporate one or more inventive aspects of the present disclosure is provided. In particular, the exemplary gas turbine engine of FIG. 1A is a configured as a single unducted rotor engine 10 defining axial direction A, radial direction R, and circumferential direction C. As is seen from FIG. 1A, engine 10 takes the form of an open rotor propulsion system and has a rotor assembly 12 which includes an array of airfoils arranged around a centerline 14 of engine 10, and more particularly includes an array of rotor blades 16 arranged around the central longitudinal axis 14 of engine 10.

Moreover, as will be explained in more detail below, engine 10 additionally includes a non-rotating vane assembly 18 positioned aft of rotor assembly 12 (i.e., non-rotating with respect to the central axis 14), which includes an array of airfoils also disposed around central axis 14, and more particularly includes an array of vanes 20 disposed around central axis 14. The rotor blades 16 are arranged in typically equally spaced relation around the centerline 14, and each blade has a root 22 and a tip 24 and a span defined therebetween. Similarly, the vanes 20 are also arranged in typically equally spaced relation around the centerline 14, and each has a root 26 and a tip 28 and a span defined therebetween. Rotor assembly 12 further includes a hub located forward of the plurality of rotor blades 16.

Additionally, engine 10 includes a turbomachine 30 having a core (or high pressure/high speed system) 32 and a low pressure/low speed system. It will be appreciated that as used herein, the terms “speed” and “pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The core 32 generally includes a high-speed compressor 34, a high speed turbine 36, and a high speed shaft 38 extending therebetween and connecting the high speed compressor 34 and high speed turbine 36. The high speed compressor 34, the high speed turbine 36, and the high speed shaft 38 may collectively be referred to as a high speed spool of the engine. Further, a combustion section 40 is located between the high speed compressor 34 and high speed turbine 36. The combustion section 40 may include one or more configurations for receiving a mixture of fuel and air, and providing a flow of combustion gasses through the high speed turbine 36 for driving the high speed spool.

The low speed system similarly includes a low speed turbine 42, a low speed or low pressure compressor or booster, 44, and a low speed shaft 46 extending between and connecting the low speed compressor 44 and low speed turbine 42. The low speed compressor 44, the low speed turbine 42, and the low speed shaft 46 may collectively be referred to as a low speed spool 55 of the engine. Although engine 10 is depicted with the low speed compressor 44 positioned forward of the high speed compressor 34, in certain embodiments the compressors 34, 44 may be in an interdigitated arrangement. Additionally, or alternatively, although engine 10 is depicted with the high speed turbine 36 positioned forward of the low speed turbine 42, in certain embodiments the turbines 36, 42 may similarly be in an interdigitated arrangement.

Referring still to FIG. 1A, the turbomachine 30 is generally encased in a cowl 48. Moreover, it will be appreciated that the cowl 48 defines at least in part an inlet 50 and an exhaust 52, and includes a turbomachinery flowpath 54 extending between the inlet 50 and the exhaust 52. The inlet 50 is for the embodiment shown an annular or axisymmetric 360 degree inlet 50 located between the rotor blade assembly 12 and the fixed or stationary vane assembly 18, and provides a path for incoming atmospheric air to enter the turbomachinery flowpath 54 (and compressors 44, 34, combustion section 40, and turbines 36, 42) inwardly of the guide vanes 28 along the radial direction R. Such a location may be advantageous for a variety of reasons, including management of icing performance as well as protecting the inlet 50 from various objects and materials as may be encountered in operation. However, in other embodiments, the inlet 50 may be positioned at any other suitable location, e.g., aft of the vane assembly 18, arranged in a non-axisymmetric manner, etc.

As is depicted, rotor assembly 12 is driven by the turbomachine 30, and more specifically, is driven by the low speed spool 55. More specifically, still, engine 10 in the embodiment shown in FIG. 1A includes a power gearbox 56, and rotor assembly 12 is driven by the low speed spool 55 of the turbomachine 30 across the power gearbox 56. In such a manner, the rotating rotor blades 16 of rotor assembly 12 may rotate around the axis 14 and generate thrust to propel engine 10, and hence an aircraft to which it is associated, in a forward direction F. The power gearbox 56 may include a gearset for decreasing a rotational speed of the low speed spool 55 relative to the low speed turbine 42, such that rotor assembly 12 may rotate at a slower rotational speed than the low speed spool 55.

As briefly mentioned above engine 10 includes a vane assembly 18. The vane assembly 18 extends from the cowl 48 and is positioned aft of rotor assembly 12. The vanes 20 of the vane assembly 18 may be mounted to a stationary frame or other mounting structure and do not rotate relative to the central axis 14. For reference purposes, FIG. 1A also depicts the forward direction with arrow F, which in turn defines the forward and aft portions of the system. As shown in FIG. 1A, rotor assembly 12 is located forward of the turbomachine 30 in a “puller” configuration, and the exhaust 52 is located aft of the guide vanes 28. As will be appreciated, the vanes 20 of the vane assembly 18 may be configured for straightening out an airflow (e.g., reducing a swirl in the airflow) from rotor assembly 12 to increase an efficiency of engine 10. For example, the vanes 20 may be sized, shaped, and configured to impart a counteracting swirl to the airflow from the rotor blades 16 so that in a downstream direction aft of both rows of airfoils (e.g., blades 16, vanes 20) the airflow has a greatly reduced degree of swirl, which may translate to an increased level of induced efficiency.

Referring still to FIG. 1A, it may be desirable that the rotor blades 16, the vanes 20, or both, incorporate a pitch change mechanism such that the airfoils (e.g., blades 16, vanes 20, etc.) can be rotated with respect to an axis of pitch rotation either independently or in conjunction with one another. Such pitch change can be utilized to vary thrust and/or swirl effects under various operating conditions, including to adjust a magnitude or direction of thrust produced at the rotor blades 16, or to provide a thrust reversing feature which may be useful in certain operating conditions such as upon landing an aircraft, or to desirably adjust acoustic noise produced at least in part by the rotor blades 16, the vanes 20, or aerodynamic interactions from the rotor blades 16relative to the vanes 20. More specifically, for the embodiment of FIG. 1A, rotor assembly 12 is depicted with a pitch change mechanism 58 for rotating the rotor blades 16 about their respective pitch axes 60, and the vane assembly 18 is depicted with a pitch change mechanism 62 for rotating the vanes 20 about their respective pitch axes 64.

It will be appreciated, however, that the exemplary single rotor unducted engine 10 depicted in FIG. lA is by way of example only, and that in other exemplary embodiments, engine 10 may have any other suitable configuration, including, for example, any other suitable number of shafts or spools, turbines, compressors, etc.; fixed-pitch blades 16, 20, or both; a direct-drive configuration (i.e., may not include the gearbox 56); etc. For example, in other exemplary embodiments, engine 10 may be a three-spool engine, having an intermediate speed compressor and/or turbine. In such a configuration, it will be appreciated that the terms “high” and “low,” as used herein with respect to the speed and/or pressure of a turbine, compressor, or spool are terms of convenience to differentiate between the components, but do not require any specific relative speeds and/or pressures, and are not exclusive of additional compressors, turbines, and/or spools or shafts.

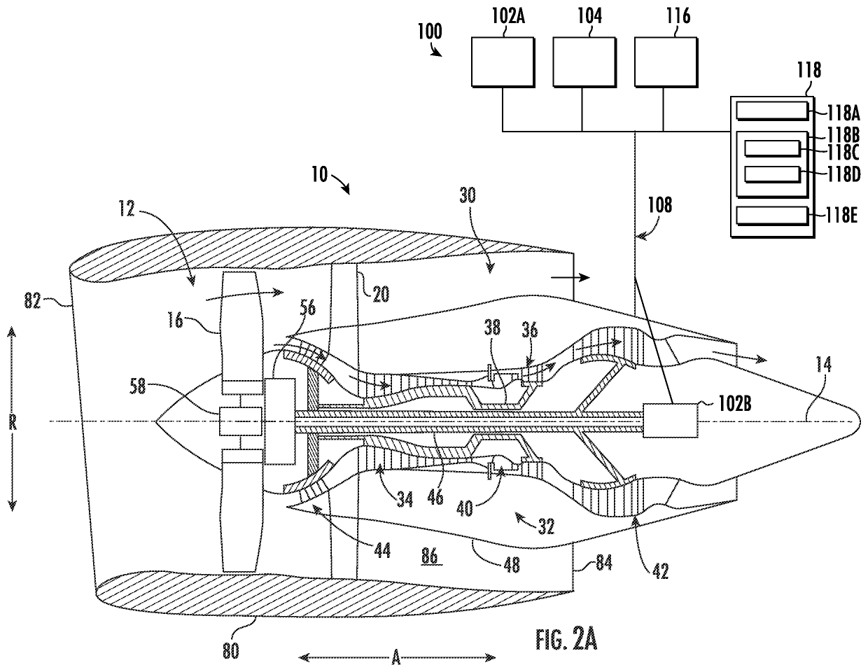

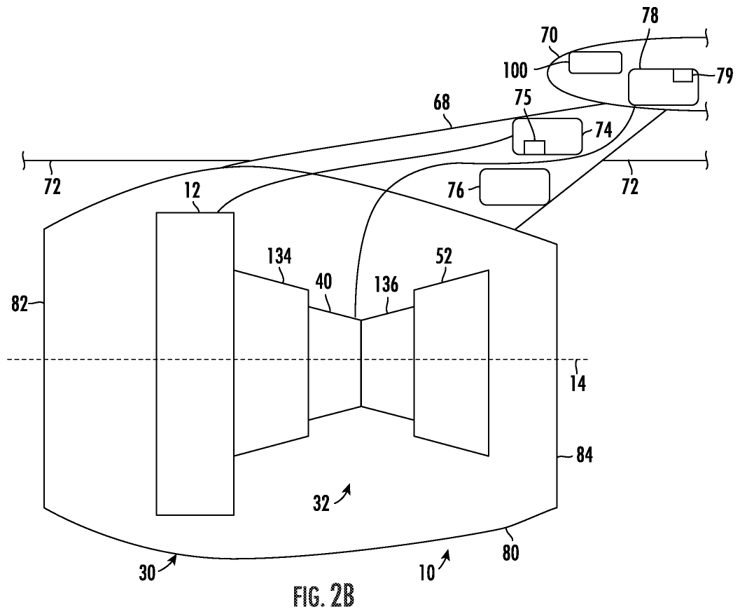

Additionally, or alternatively, in other exemplary embodiments, any other suitable gas turbine engine may be provided. For example, in other exemplary embodiments, the gas turbine engine may be a turboshaft engine, a turboprop engine, turbojet engine, etc. Moreover, for example, although the engine is depicted as a single unducted rotor engine, in other embodiments, the engine may include a multi-stage open rotor configuration, and aspects of the disclosure described hereinbelow may be incorporated therein. Further, still, in other exemplary embodiments, engine 10 may be configured as a ducted turbofan engine (see e.g., FIGS. 2A-2B).

With respect to FIG. 1A, it will be appreciated that the engine is integrated with an electric power system 100. The electric power system 100 generally includes an electric machine 102A, an electric machine 102B, and an electric energy storage unit 104. Further, for the embodiment shown, electric machines 102A and 102B of the electric power system 100 are in electrical communication with the electric power bus 108.

For the embodiment shown, electric machine 102B of the electric power system 100 is a low pressure electric machine coupled to the low pressure system of engine 10. Electric machine 102B is rotatable with the rotating low speed shaft 46 and is configured to generate electric power. Electric machine 102B is driven by engine 10 and is configured to generate electric power. In this example, an accessory system is provided. The accessory system is configured to receive at least a portion of the electric power generated by electric machine 102B. As used herein, the term “accessory system” can refer to any system operable with the engine 10 to facilitate operation of the engine 10. In certain exemplary embodiments, the accessory systems may refer to one or more of a lubrication system 74, an accessory 76, a fuel system 78, an engine controller 116, or an electrical power system 100.

For the embodiment shown, electric machine 102B is embedded within engine 10, at a location within or aft of the turbine section of engine 10, and inward of the core airflow path 54 through engine 10 along the radial direction R. It will be appreciated, however, that in other example embodiments, electric machine 102B may additionally, or alternatively, be configured in the other suitable manner. For example, in other embodiments, electric machine 102B may be embedded within a compressor section (e.g., high speed compressor 34 or low speed compressor 44) of engine 10, may be located outward of core airflow path 54 along the radial direction R (and, e.g., within the cowl 48), etc. Electric machine 102B is in electrical communication with electric energy storage unit 104.

In at least certain exemplary embodiments, the electric energy storage unit 104 may include one or more batteries. Additionally, or alternatively, the electric energy storage unit 104 may include one or more supercapacitor arrays, one or more ultracapacitor arrays, or both. In at least certain embodiments, the electric energy storage unit 104 may be configured to provide at least 5 kilowatts (kW) of energy to the electric power system 100, such as at least 50 kW, such as at least 50 kW, such as at least 250 kW, such as at least 300 kW, such as at least 350 kW, such as at least 400 kW, such as at least 500 kW, such as up to 5 megawatts (MW), such as up to 10 megawatts (MVV). Further, the electric energy storage unit 104 may be configured to provide such electrical power for at least two minutes, such as at least three minutes, such as at least five minutes, such as up to an hour. Further, still, in other embodiments, the electric energy storage unit 104 may be configured to provide such electrical power for any other suitable duration. Moreover, for the embodiment shown, the electric power system 100 includes an electric power bus 108 electrically connecting the various components of electric power system 100. The electric power bus 108 may be, e.g., one or more electrical lines arranged in any suitable configuration.

Referring still to the exemplary embodiment of FIG. 1A, although not depicted, it will be appreciated that the exemplary electric power system may also include an auxiliary power unit (“APU”). The APU, if included, may include a combustion engine driving an electric generator, and may be located remotely from engine 10. For example, in at least certain exemplary embodiments, the APU, if provided, may be located within a fuselage of the aircraft utilizing engine 10, e.g., at an aft end of the aircraft, and electrically coupled to the electric power bus 108.

Referring still to FIG. 1A, the exemplary electric power system 100 is operably connected to a controller 116. Controller 116 may be an engine controller for engine 10 (e.g., an EECU, such as a FADEC), may be an aircraft controller, may be a controller dedicated to the electric power system 100, etc. In this example, controller 116 is configured to control operations of engine 10. In other examples, controller 116 may be configured to receive data indicative of various operating conditions and parameters of engine 10 during operation of engine 10. Referring particularly to the operation of controller 116, in at least certain embodiments, controller 116 can include one or more computing device(s) 118.

The computing device(s) 118 can include one or more processor(s) 118A and one or more memory device(s) 118B. The one or more processor(s) 118A can include any suitable processing device, such as a microprocessor, microcontroller, integrated circuit, logic device, and/or other suitable processing device. The one or more memory device(s) 118B can include one or more computer-readable media, including, but not limited to, non-transitory computer-readable media, RAM, ROM, hard drives, flash drives, and/or other memory devices.

The one or more memory device(s) 118B can store information accessible by the one or more processor(s) 118A, including computer-readable instructions 118C that can be executed by the one or more processor(s) 118A. The instructions 118C can be any set of instructions that when executed by the one or more processor(s) 118A, cause the one or more processor(s) 118A to perform operations. In some embodiments, the instructions 118C can be executed by the one or more processor(s) 118A to cause the one or more processor(s) 118A to perform operations, such as any of the operations and functions for which the controller 116 and/or the computing device(s) 118 are configured, the operations for operating an electric power system 100, as described herein, and/or any other operations or functions of the one or more computing device(s) 118. The instructions 118C can be software written in any suitable programming language or can be implemented in hardware. Additionally, and/or alternatively, the instructions 118C can be executed in logically and/or virtually separate threads on processor(s) 118A. The memory device(s) 118B can further store data 118D that can be accessed by the processor(s) 118A. For example, the data 118D can include data indicative of power flows, data indicative of engine 10/aircraft operating conditions, and/or any other data and/or information described herein.

The computing device(s) 118 can also include a network interface 118E used to communicate, for example, with the other components of engine 10, the aircraft incorporating engine 10, the electric power system 100, etc. The controller 116 is operably coupled to these components through, e.g., the network interface 118E, such that the controller 116 may receive data indicative of various operating parameters during operation, various operating conditions of the components, etc., and further may provide commands to control electrical flow of the electric power system 100 and other operating parameters of these systems.

The network interface 118E can include any suitable components for interfacing with one or more network(s), including for example, transmitters, receivers, ports, controllers, antennas, and/or other suitable components. For example, in the embodiment shown, the network interface 118E is configured as a wired communication network in communication with these components. In another example, computing device(s) 118 can be wirelessly connected to any portions or components of engine 10.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Referring now to FIG. 1B, FIG. 1B is a simplified schematic view of engine 10 mounted on an aircraft 66 with accessory systems of the engine 10 (e.g., lubrication system 74, accessory 76, fuel system 78 (with fuel pump 79), engine controller 116, and electrical power system 100) mounted off of and away from engine 10. FIG. 1B shows engine 10 (including rotor assembly 12, centerline 14, waterline W_{L}, turbomachine 30, core 32, compressor section 134, combustion section 40, turbine section 136, cowl 48 (with inlet 50, outlet 51, and exhaust 52), aircraft 66 (including pylon 68, wing, 70, and fuselage 72), supply line 73A, scavenge line 73B, lubrication system 74 (with pump 75), accessory 76, fuel system 78, and electric power system 100. The exemplary embodiment of FIG. 1B may be configured in substantially the same manner as the exemplary engine 10 described above with respect to FIG. 1A, and the same or similar reference numerals may refer to the same or similar parts.

In this example, engine 10 defines a waterline W_{L}. Waterline W_{L} can be the highest point in engine 10 where a liquid (e.g., lubricant, fuel, etc.) is flowing into or through engine 10 (e.g., with the “highest point” being defined relative to the up and down directions as shown in FIG. 1B). In other words, waterline WL can be the highest point within engine 10 where a fluid rests when everything (e.g., all components of engine 10) is turned off.

Compressor section 134 is a section of engine 10 that compresses air received from fan section 20. Turbine section 136 is a section of engine 10 where the combusted fuel and air are used to power/drive a turbine. Pylon 68 is a casing and/or a structure used to mount objects to aircraft wings. Wing 70 is an airfoil-shaped body used to create lift for aircraft 66. Fuselage 72 is the main body of aircraft 66.

Supply line 73A and scavenge line 73B are conduits or piping configured to transport a fluid (e.g., lubricant). In one example, supply line 73A and/or scavenge line 73B may include check valves to limit or prevent flow. Lubrication system 74 is a system or assembly of components for managing oil or lubricant for engine 10. For example, the lubrication system 74 may be configured to deliver lubricant to one or more bearings within the engine 10. The lubricant may lubricate the bearings and may further act as a thermal management system for the bearings and other components of the engine 10. In one example, lubrication system 74 can include tank 75 for holding a volume of lubricant and a pump for providing a flow of lubricant through the lubrication system 74 (e.g., to the bearings and/or from one or more sumps housing the bearings).

Accessory 76 is a component or group of components that are necessary for operation of engine 10 (and/or aircraft 66) but that is/are not part of the core combustion drive functionality of engine 10. For example, accessory 76 can include one or more of an actuator (e.g., electrically, hydraulically, or pneumatically driven), a power source, a hydraulic pump, a pneumatic pump, a sensor, a blower (e.g., to provide an airflow through the core air flowpath following a shutdown of the engine for soakback functionality), an electronics unit, and/or a valve. In one example, accessory 76 can be electrically powered (e.g., by electric machine 102A, electric machine 102B, and/or electric energy storage unit 104 of electric power system 100).

Fuel system 78 is a system or assembly of components (including fuel pump 79) for managing fuel used by engine 10 (e.g., for combustion). Fuel pump 79 is disposed to supply fuel to portions of engine 10, such as to the combustion section 40 of the engine 10. Fuel pump 79 is also disposed as the downstream-most fuel pump in fluid communication with combustion section 40 of engine 10. In this example fluid pump 79 is a a variable speed, electrically-driven fuel pump. The fuel pump 79 may be an electrically powered fuel pump, configured to receive electrical power from the electric machine 102A, the electric machine 102B, the electric energy storage unit 104, or a combination thereof. In such a manner, it will be appreciated that the fuel pump may be a variable speed fuel pump 79, capable of operating at variable speeds (to provide variable volumes of fuel to the combustion section 40 of the engine 10), independent of a rotational speed of the engine 10, such as independent of a rotational speed of the LP shaft 55, the HP shaft 38, or both. In such a manner, the fuel system 78 may not require a fuel metering unit located locally to the combustion section. In such a manner, it will be appreciated that the fuel pump 79 may be the downstream-most fuel pump in fluid communication with combustion section 40 of engine 10.

In one example, electric power system 100 is as described with respect to FIG. 1A and includes electric machines 102A and 102B, electric energy storage unit 104, electric power bus 108, controller 116 and computing device(s) 118. In other examples, electric power system 100 can include more or less components than discussed with respect to FIG. 1A, such as for example, various power electronics, electric lines, etc.

For the embodiment shown, the engine controller 116 is also provided. The engine controller 116 may be an EECU, such as a FADEC. The engine controller 116 may be operably coupled to various sensors, actuators, valves, etc. of the engine 10, as well as to one or more of the accessory systems, such as the fuel pump 79 of the fuel system 78. In such a manner, the engine controller 116 may control operation of the engine 10.

Engine 10 is mounted to a lower end of pylon 68. Compressor section 134 is disposed downstream of and in fluid communication with rotor assembly 12. Compressor section 134 is also disposed upstream of and in fluid connection with combustion section 40. Turbine section 136 is disposed downstream of and in fluid communication with combustion section 40. Turbine section 136 is also disposed upstream of and in fluid connection with exhaust 52. For example, compressor section 134, combustion section 40, and turbine section 136 in arranged serial flow order. Pylon 68 is mounted to wing 70 and extends between engine 10 and wing 70. Wing 70 is attached to and extends outward from fuselage 72.

In this example, the accessory system (e.g., lubrication system 74, accessory 76, fuel system 78, engine controller 116, and electrical power system 100) is mounted remotely from engine 10. As used herein, the term “remotely from the engine” refers to a location outside of an outermost casing of the engine 10, such as the cowl 48 for the unducted engine 10 depicted in FIGS. 1A and 1B, or outside of the cowl 48 and outside of an outer nacelle (e.g., outer nacelle 80 discussed below with respect to FIGS. 2A-2B) for a ducted engine.

The accessory systems are operable with engine 10 (e.g., supports operation of the engine 10 or is dependent on the operation of the engine 10). Also, for the embodiment shown, at least certain of the accessory systems are configured to receive electric power generated from the engine 10. More specifically, in certain exemplary embodiments, one or more of the accessory systems may also be in electrical communication with one or more of electric machine 102A, electric machine 102B, and electric energy storage unit 104.

In this example, supply line 73A and scavenge line 73B extend between and are fluidly connected to lubrication system 74 and compressor section 134 of engine 10. Lubrication system 74 is mounted to and located in pylon 68. In other examples, lubrication system 74 can be located in other areas of aircraft 66 such as in wing 70, fuselage 72, or other areas of aircraft 66 away from engine 10. In this example, lubrication system 74 can be fluidly connected to any of rotor assembly 12 or compressor section 134 via supply line 73A. Accessory 76 is mounted to and located in pylon 68. In other examples, accessory 76 can be located in other areas of aircraft 66 such as in wing 70 or fuselage 72. Fuel system 78 is mounted to and located in wing 70. In other examples, fuel system 78 can be located other areas of aircraft 66 away from engine 10 such as in pylon 68 or in fuselage 72. Engine controller 116 is mounted to and located in wing 70. In other examples, engine controller 116 can be located other areas of aircraft 66 away from engine 10 such as in pylon 68 or in fuselage 72. Electric power system 100 is mounted to and located in wing 70. In other examples, electric power system 100 can be located other areas of aircraft 66 away from engine 10 such as in pylon 68 or in fuselage 72.

In one example, lubrication system 74 can be configured to provide a lubricant to various bearings and gear meshes in compressor section 134 and turbine section 136. The lubricant provided by lubrication system 74 increases the useful life of such components and removes a certain amount of heat from such components. Lubrication system 74 can also be configured to prime and/or purge lubrication system 74 as well as include a trap or traps. Due to lubrication system 74 being mounted remotely from engine 10, oil may need to be scavenged from compressor section 134 for an amount of time after engine 10 is shut down. For example, a volume of oil in supply line 73A or scavenge line 73B can be approximately one liter due to an extended length of supply line 73A (and scavenge line 73B) of 15-20 feet (e.g., 4.6 to 6.1 meters). With the extra amount of oil that may be in compressor section 134, in supply line 73A, and/or in scavenge line 73B, oil may be scavenged from compressor section 134, supply line 73A, and/or scavenge line 73B for a period from 20 seconds up to 180 seconds. In such an example, lubrication system 74 may include some sensors configured to sense how much oil is present in compressor section 134, in supply line 73A, and/or in scavenge line 73B upon shut-down on engine 10. In yet another example, tank 75 or pump of lubrication system 74 can be located above waterline W_{L} of engine 10.

In one example, accessory 76 can be powered by electric, pneumatic, or hydraulic actuation thereby enabling accessory 76 to be powered in a manner that decouples accessory 76 from an accessory gearbox (not shown in FIGS. 1A or 1B) of engine 10. Put another way, accessory 76 is mechanically uncoupled from engine 10 (e.g., from an accessory gearbox of engine 10) which enables accessory 76 to be driven or powered by electric, pneumatic, or hydraulic actuation from a source other than the accessory gearbox of engine 10. In one example, fuel system 78 can be configured to supply fuel to combustion section 40 of engine 10. In other examples, fuel system 78 can be configured to supply fuel to other portions of aircraft 66 that utilize fuel for functionality (e.g., the APU).

As shown in FIG. 1B, the accessory systems (e.g., lubrication system 74, accessory 76, fuel system 78, engine controller 116, and electrical power system 100) of engine 10 are installed remotely from the engine 10, in an off-engine location such as in pylon 68, wing 70, and fuselage 72. This off-engine location of the accessory systems of engine 10 enable optimization for overall vehicle aerodynamics, weight, and maintainability, as well as potentially eliminating a need for the accessory gearbox of engine 10. In such installation locations away from engine 10 (as in pylon 68, wing 70, and fuselage 72), those locations experience a less severe thermal and vibratory environment as compared to on-engine mounting locations.

Moreover, mounting the accessory systems (e.g., lubrication system 74, accessory 76, fuel system 78, engine controller 116, and electrical power system 100) in an off-engine location, (e.g., in pylon 68, wing 70, and fuselage 72), can allow for a reduction in a frontal cross-sectional area of engine 10, for utilization of space that may otherwise be unoccupied in aircraft 66, and for optimization of overall system weight, installed performance, parasitic losses, and maintainability. In other examples, the accessory systems can be located in other locations throughout aircraft 66 that are desirable for airframe integration. In one such example, the accessory systems can be mounted forward or aft of wing 70, as well as along a center of gravity of aircraft 66 or of fuselage 72. For example, if the accessory systems were mounted in pylon 68, an increase in cross-sectional area may be required of pylon 68 in order to fit the accessory systems in pylon 68. In some instances, this increase in size of pylon 68 may be acceptable. In other instances, if an increase in size of pylon 68 is undesirable, the accessory systems can be located in wing 70 or in fuselage 72.

Additionally, remote mounting of the accessory systems in pylon 68, wing 70, or fuselage 72 can enable redundant use of the accessory systems across various engines of aircraft 66. For example, more than one engine 10 can utilize the accessory systems when the accessory systems are uncoupled from the turbomachinery of a single engine 10. In particular, redundancies in lubrication system 74, accessory 76, fuel system 78, engine controller 116, and electrical power system 100 can be utilized on a per wing basis or a per aircraft basis.

In this embodiment with the unducted rotor assembly 12, accessory systems (e.g., lubrication system 74, accessory 76, fuel system 78, engine controller 116, and electrical power system 100) can be mounted off engine to enable optimum weight, installation environment, and maintenance access to the accessory systems. For example, the size impacts of cowl 48 can be proportionally greater, and the thermal environment inside cowl 48 may be greater in temperature than a conventional turbofan. Due to these increased temperature within cowl 48, it can be beneficial to move the accessory systems away from core 32 and in other parts of aircraft 66 with more benign thermal and vibratory conditions. In another example, operating fuel pump 79 of fuel system 78 in reverse after shutdown of engine 10 could also allow elimination of check valves in fuel system 78 and a purging of fuel in the fuel nozzles to prevent fuel system coking.

It will be appreciated that although for the embodiment depicted in FIG. 1B the engine 10 is mounted to the wing 70 through the pylon 68, in other exemplary embodiments, the engine 10 may alternatively be mounted in any other suitable manner. For example, in other exemplary embodiments, the engine 10 may be mounted at any other freestream location (e.g., spaced from the fuselage 72 and/or wing 70), such as to a stabilizer of the aircraft 66 (not show), to the fuselage 72 of the aircraft 66, etc. Additionally, or alternatively, in still other embodiments, the engine 10 may be integrated into a portion of the aircraft 66, such as into a portion of a wing 70 of the aircraft 66, the fuselage 72 of the aircraft 66, etc. In one or more of these embodiments, the accessory system(s) may still be mounted remotely from the engine 10.

FIG. 2A is a schematic, cross-sectional view of a second gas turbine engine in accordance with another exemplary embodiment of the present disclosure. For example, an engine 10 in accordance with another exemplary embodiment of the present disclosure is depicted in FIG. 2A. The exemplary embodiment of FIG. 2A may be configured in substantially the same manner as the exemplary engine 10 and electrical power system 100 described above with respect to FIGS. 1A-1B, and the same or similar reference numerals may refer to the same or similar parts. However, as will be appreciated, for the embodiment shown in FIG. 2A, engine 10 further includes a nacelle 80 circumferentially surrounding at least in part rotor assembly 12 and turbomachine 30, defining a bypass passage 82 therebetween.

Referring now to FIG. 2B, FIG. 2B is a simplified schematic view of engine 10 mounted on an aircraft 66 with engine accessory systems (e.g., lubrication system 74, accessory 76, fuel system 78, engine controller 116, and electrical power system 100) mounted off of and away from engine 10. FIG. 2B shows engine 10 (including rotor assembly 12, centerline 14, turbomachine 30, core 32, compressor section 134, combustion section 40, turbine section 136, exhaust 52, aircraft 66 (including pylon 68, wing, 70, and fuselage 72), lubrication system 74 (with tank 75), accessory 76, fuel system 78 (with pump 79), nacelle 80 (including inlet 82, and outlet 84), and electric power system 100. The exemplary embodiment of FIG. 2B may be configured in substantially the same manner as the exemplary engine 10 described above with respect to FIG. 2A, and the same or similar reference numerals may refer to the same or similar parts.

With the embodiment(s) shown in FIGS. 2A and 2B, a ducted fan arrangement is shown for engine 10. Similar to the embodiment(s) shown in FIGS. 1A and 1B, the accessory systems (e.g., lubrication system 74, accessory 76, fuel system 78, engine controller 116, and electrical power system 100) are located away from and off of core 32 of engine 10. With mounting the accessory systems off of and away from core 32, the accessory systems can be powered with a means other than the mechanical drive from the turbomachinery of engine 10 (e.g., with electrical power system 100). Powering the accessory systems with a means other than the turbomachinery of engine 10 facilitates operation of the accessory systems and their associated systems prior to and after shutdown of engine 10. For example, operating lubrication system 74 after shutdown of engine 10 allows removal of thermal energy that might otherwise lead to coking in lubrication system 74 (or in other parts of engine 10).

Locating the accessory systems away from engine 10 also enables improvement and optimization of mounting location, installed environment, and maintenance access to the accessory systems. This is due in part to the architectural and volumetric constraints within nacelle 80. Regarding the remote location of lubrication system 74, the remotely located oil tank (e.g., tank 75) in lubrication system 74 can allow for an oil level check and fill without requiring nacelle 80 to be opened, as well as allowing for placement of oil filters, scavenge screens, and chip detectors in areas that allow servicing without opening cowl 48. These and other factors lead to process improvements such as decreased maintenance time.

It will be appreciated that although for the embodiment depicted in FIG. 2B the engine 10 is mounted to the wing 70 through the pylon 68, in other exemplary embodiments, the engine 10 may alternatively be mounted in any other suitable manner. For example, in other exemplary embodiments, the engine 10 may be mounted at any other freestream location (e.g., spaced from the fuselage 72 and/or wing 70), such as to a stabilizer of the aircraft 66 (not show), to the fuselage 72 of the aircraft 66, etc. Additionally, or alternatively, in still other embodiments, the engine 10 may be integrated into a portion of the aircraft 66, such as into a portion of a wing 70 of the aircraft 66, the fuselage 72 of the aircraft 66, etc. In one or more of these embodiments, the accessory system(s) may still be mounted remotely from the engine 10.

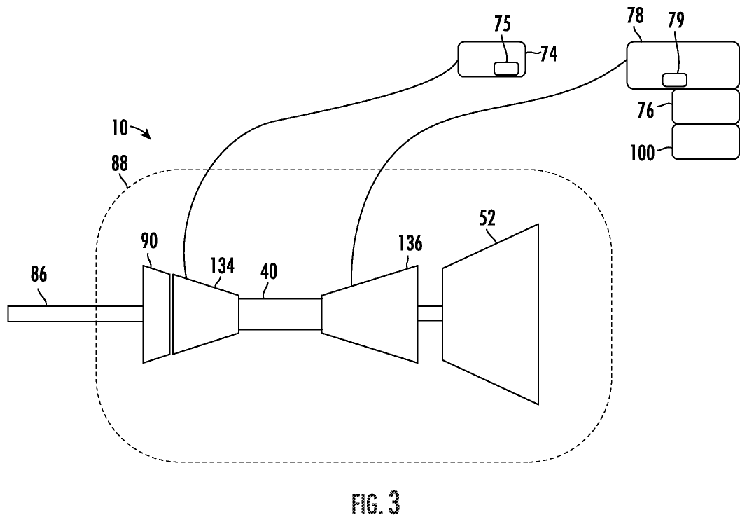

Referring now to FIG. 3, FIG. 3 is a simplified schematic view of a turboshaft assembly 86 of engine 10 and shows engine accessory systems mounted outside of heat zone 88 of the turboshaft assembly. FIG. 3 shows combustion section 40, exhaust 52, lubrication system 74, accessory 76, fuel system 78, turboshaft assembly 86, heat zone 88, fan section 90, electric power system 100, compressor section 134, and turbine section 136. As shown, FIG. 3 omits some elements of engine 10 and aircraft 66 in the interest of clarity. Accordingly, the embodiment depicted herein, that of heat zone 88 and the relative location of the accessory systems, can apply to the other embodiments shown throughout and as depicted in FIGS. 1A-2B.

Turboshaft assembly 86 includes one or more rotating shafts. In example, turboshaft assembly 86 can include one or more of high speed shaft 38, low speed shaft 46, or low speed spool 55 as discussed with respect to FIG. 1A. Heat zone 88 is defined by a temperature zone surrounding a portion of engine 10 with heat zone 88 having an average temperature of at least 250° F. (or 121° Celsius) throughout heat zone 88 during steady-state operation of the engine at cruise operating conditions. In at least certain embodiments, heat zone 88 can include an average boundary temperature of at least 150° F. (e.g., 65.6° C.), such as at least 175° F. (e.g., 79.4° C.), such as at least 200° (e.g., 93.3° C.), such as at least 225° (e.g., 107° C.), such as at least 250° F. (e.g., 121° C.). In this example, heat zone 88 is generally cylindrical in shape and heat zone 88 extends radially outward from turboshaft assembly 86. In other embodiments, a shape of heat zone 88 can correspond to more precise temperature envelopes defined by temperature signatures throughout the various sections of engine 10. Fan section 90 is a section of engine 10 that can include either a ducted (see e.g., FIGS. 2A-2B) or unducted (see e.g., FIGS. 1A-1B) rotor assembly 12

As shown in FIG. 3, the accessory systems (e.g., lubrication system 74, accessory 76, fuel system 78, and electric power system 100) are mounted and/or located outside of heat zone 88. Locating the accessory systems outside of heat zone 88 reduces instances of the oil of lubrication system 74 and of the fuel of fuel system 78 igniting and combusting in locations other than the intended location within engine 10. For example, being located away from core 32 of engine 10, the accessory systems experience more benign thermal conditions thereby allowing the lubricating oil and fuel of the accessory systems to remain at relatively low temperature levels. This potentially improves safety as well as improving the life of the components of engine 10, lubrication system 74, accessory 76, fuel system 78, and electric power system 100.

This written description uses examples to describe the disclosure, including the best mode, and also to enable any person skilled in the art to practice the disclosed embodiments, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

An aircraft includes a fuselage, a wing connected to and extending from the fuselage, a pylon mounted to a portion of the wing, an engine attached to the pylon, and an accessory system. The accessory system is mounted remotely from the engine and includes at least one of a fuel pump and a lubrication system. The fuel pump is disposed to supply fuel to portions of the engine and is the downstream-most fuel pump in fluid communication with the combustion section. The lubrication system is disposed to provide oil to portions of the engine.

The aircraft of one or more of these clauses further comprising an electrical system having an electric machine driven by the engine and configured to generate electric power, wherein the accessory system is configured to receive at least a portion of the electric power.

The aircraft of one or more of these clauses wherein the electrical system further comprises an electric energy storage unit, wherein the electric machine is in electrical communication with the electric energy storage unit, and wherein the accessory system is in electrical communication with the electric machine, the electric energy storage unit, or both.

The aircraft of one or more of these clauses wherein the accessory system is mounted in or to the pylon, the wing, or the fuselage.

The aircraft of one or more of these clauses wherein the accessory system comprises the lubrication system, wherein the lubrication system comprises an oil tank mounted above a water line of the engine.

The aircraft of one or more of these clauses wherein the accessory system comprises the fuel pump, and wherein the fuel pump is a variable speed, electrically-driven fuel pump.

The aircraft of one or more of these clauses wherein the engine comprises: a fan section at an upstream end of the engine; a compressor section in fluid communication with and disposed downstream from the fan section; a turbine section in fluid communication with and disposed downstream from the combustion section; and a rotating shaft disposed to drivingly connect the turbine to the compressor.

The aircraft of one or more of these clauses wherein the accessory assembly is disposed to be driven separately from the rotating shaft of the engine.

The aircraft of one or more of these clauses wherein the fan section includes an unducted fan.

The aircraft of one or more of these clauses wherein a heat zone of the engine is defined by a temperature zone surrounding a portion of the engine with an average temperature of at least 250 degrees Fahrenheit during operation of the engine, wherein the components of the accessory system are mounted outside of the heat zone.

The aircraft of one or more of these clauses wherein the accessory system further comprises at least one of a hydraulic pump, a pneumatic pump, or a sensor.

The aircraft of one or more of these clauses wherein the accessory system further comprises an engine controller configured to control operations of the engine.

An engine assembly for an aircraft includes an engine, an electrical system, and an accessory system. The engine includes a compressor section, a combustion section, and a turbine section in serial flow order. The engine further includes a rotating shaft rotatable with the compressor section, the turbine section, or both. The electrical system includes an electric machine rotatable with the rotating shaft and is configured to generate electric power. The accessory system is mounted remotely from the engine and is disposed to be driven separately from the rotating shaft of the engine.

The engine assembly of one or more of these clauses wherein the accessory system comprises at least one of: a fuel pump disposed to supply fuel to portions of the engine, the fuel pump being the downstream-most fuel pump in fluid communication with the combustion section; a lubrication system disposed to provide oil to portions of the engine; or an engine controller configured to control operations of the engine.

The engine assembly of one or more of these clauses wherein the accessory system comprises the lubrication system, wherein the lubrication system comprises an oil tank mounted above a water line of the engine.

The engine assembly of one or more of these clauses wherein the accessory system comprises the fuel pump, and wherein the fuel pump is a variable speed, electrically-driven fuel pump.

The engine assembly of one or more of these clauses wherein the electrical system further comprises: an electric energy storage unit, wherein the electric machine is in electrical communication with the electric energy storage unit, and wherein the accessory system is in electrical communication with the electric machine, the electric energy storage unit, or both.

The engine assembly of one or more of these clauses wherein the accessory system is operable with the engine and is configured to receive electric power generated from the electric machine.

The engine assembly of one or more of these clauses wherein the accessory system is configured to mount in or to a pylon, a wing, or a fuselage of the aircraft.

The engine assembly of one or more of these clauses wherein a heat zone of the engine is defined by a temperature zone surrounding a portion of the engine with an average temperature of at least 250 degrees Fahrenheit, wherein the components of the accessory system are mounted outside of the heat zone.

We claim:

1. An aircraft comprising:
a fuselage;
a wing connected to and extending from the fuselage;
a pylon mounted to a portion of the wing;
an engine attached to the pylon, the engine comprising a combustion section; and
an accessory system mounted remotely from the engine, wherein the accessory system comprises at least one of:
a fuel pump disposed to supply fuel to portions of the engine, the fuel pump being the downstream-most fuel pump in fluid communication with the combustion section; or
a lubrication system disposed to provide oil to portions of the engine.

2. The aircraft of claim 1, further comprising an electrical system having an electric machine driven by the engine and configured to generate electric power, wherein the accessory system is configured to receive at least a portion of the electric power.

3. The aircraft of claim 2, wherein the electrical system further comprises an electric energy storage unit, wherein the electric machine is in electrical communication with the electric energy storage unit, and wherein the accessory system is in electrical communication with the electric machine, the electric energy storage unit, or both.

4. The aircraft of claim 1, wherein the accessory system is mounted in or to the pylon, the wing, or the fuselage.

5. The aircraft of claim 1, wherein the accessory system comprises the lubrication system, wherein the lubrication system comprises an oil tank mounted above a water line of the engine.

6. The aircraft of claim 1, wherein the accessory system comprises the fuel pump, and wherein the fuel pump is a variable speed, electrically-driven fuel pump.

7. The aircraft of claim 1, wherein the engine comprises:
a fan section at an upstream end of the engine;
a compressor section in fluid communication with and disposed downstream from the fan section;
a turbine section in fluid communication with and disposed downstream from the combustion section; and
a rotating shaft disposed to drivingly connect the turbine to the compressor.

8. The aircraft of claim 7, wherein the accessory assembly is disposed to be driven separately from the rotating shaft of the engine.

9. The aircraft of claim 7, wherein the fan section includes an unducted fan.

10. The aircraft of claim 1, wherein a heat zone of the engine is defined by a temperature zone surrounding a portion of the engine with an average temperature of at least 250 degrees Fahrenheit during operation of the engine, wherein the components of the accessory system are mounted outside of the heat zone.

11. The aircraft of claim 1, wherein the accessory system further comprises at least one of a hydraulic pump, a pneumatic pump, or a sensor.

12. The aircraft of claim 1, wherein the accessory system further comprises an engine controller configured to control operations of the engine.

13. An engine assembly for an aircraft, the engine assembly comprising:
an engine comprising a compressor section, a combustion section, and a turbine section in serial flow order, the engine further comprising a rotating shaft rotatable with the compressor section, the turbine section, or both;
an electrical system comprising an electric machine rotatable with the rotating shaft, the electric machine configured to generate electric power; and
an accessory system mounted remotely from the engine, wherein the accessory system is disposed to be driven separately from the rotating shaft of the engine.

14. The engine assembly of claim 13, wherein the accessory system comprises at least one of:
a fuel pump disposed to supply fuel to portions of the engine, the fuel pump being the downstream-most fuel pump in fluid communication with the combustion section;
a lubrication system disposed to provide oil to portions of the engine; or
an engine controller configured to control operations of the engine.

15. The engine assembly of claim 14, wherein the accessory system comprises the lubrication system, wherein the lubrication system comprises an oil tank mounted above a water line of the engine.

16. The engine assembly of claim 14, wherein the accessory system comprises the fuel pump, and wherein the fuel pump is a variable speed, electrically-driven fuel pump.

17. The engine assembly of claim 13, wherein the electrical system further comprises:
an electric energy storage unit, wherein the electric machine is in electrical communication with the electric energy storage unit, and wherein the accessory system is in electrical communication with the electric machine, the electric energy storage unit, or both.

18. The engine assembly of claim 13, wherein the accessory system is operable with the engine and is configured to receive electric power generated from the electric machine.

19. The engine assembly of claim 13, wherein the accessory system is configured to mount in or to a pylon, a wing, or a fuselage of the aircraft.

20. The engine assembly of claim 13, wherein a heat zone of the engine is defined by a temperature zone surrounding a portion of the engine with an average temperature of at least 250 degrees Fahrenheit, wherein the components of the accessory system are mounted outside of the heat zone.
